(19) United States
(12) Patent Application Publication
(10) Pub. No.: US 2009/0211478 A1
(43) Pub. Date: Aug. 27, 2009

(54) Handling Device of a Printing Press

(75) Inventors: Thomas Gsell, Dillingen (DE); Rudolf Stroh, Duernau (DE)

Correspondence Address: COHEN, PONTANI, LIEBERMAN & PAVANE LLP, 551 FIFTH AVENUE, SUITE 1210, NEW YORK, NY, 10176, US

(73) Assignee: manroland AG, Offenbach am Main (DE)

(21) Appl. No.: 12/390,548

(22) Filed: Feb. 23, 2009

(30) Foreign Application Priority Data
Feb. 22, 2008 (DE) 10 2008 010 598.8

(51) Int. Cl. B41F 27/12

(52) U.S. Cl. 101/477

(57) ABSTRACT

A handling device for handling printing plates during an automated change of printing plates on a printing unit of a printing press includes a manipulator arm and a manipulator head with a suction device mounted on its free end. The suction device includes a crossbeam and a plurality of suction sections along the length of the crossbeam. Each suction section has a pair of suction nozzles supported in floating fashion with respect to the crossbeam and a pair of stop elements mounted on the crossbeam and arranged to limit the movement of a printing plate held by respective suction nozzles with respect to the crossbeam. The stop elements are preferably held of a pair of U-profile-shaped sections fixed to the crossbeam, these sections and the stop elements having circular openings through which the suction nozzles project.

### BACKGROUND OF THE INVENTION

1. Field of the Invention

The invention pertains to a handling device of a printing press, particularly for handling printing plates during an automated change of printing plates in a printing unit.

2. Description of the Related Art

A handling device of a printing press, especially for the handling of printing plates during an automated change of printing plates on a printing unit of a printing press is known from US2008/0156213. This handling device comprises a manipulator arm, where a manipulator head, which comprises a handling element, especially a holding element for printing plates, is assigned to one end of the manipulator arm. The handling element is designed as a suction device comprising several suction nozzles for the handling of printing plates, where two suction nozzles are present for each printing plate to be handled, these nozzles being supported in a floating manner on a common support element.

The handling device according to US2008/0156213, however, suffers from the disadvantage that, as a result of manufacturing-related and installation-related tolerances, the suction nozzles, which are designed as rubber suction cups, are compressed to different degrees when used to exert suction on several printing plates. This can result in the printing plates on the suction nozzles assigned to them being picked up at an angle. This can lead to problems later, especially when the printing plates are set down and threaded onto a plate cylinder.

A solution to this problem is known from issue No. 17 of the journal “Deutscher Drucker” of May 31, 2007, where the handling device described in US2008/0156213 is modified so that, for each suction nozzle, a permanently fixed stop in the form of an angle element is formed on the handling element. A first side piece of the angle element extends from the handling element in the longitudinal direction of the associated rubber suction cup, while a second side piece of the angle element extends at a right angle from the first side piece and thus transversely to the longitudinal direction of the associated suction nozzle. An opening, through which the suction nozzle in question extends, is provided in the second side piece. Thus the angle element in question forms a permanently fixed “spectacle” for the suction nozzle in question. The second side pieces of all the angle elements lie on a common plane.

When suction is exerted on printing plates, their printing surfaces are drawn against the associated second side piece of the angle elements or “spectacles” of the suction nozzles, so that the printing plates are fixed in a common plane, i.e., at the same height. The disadvantage of this solution, however, is that, because the printing plates are held down tightly on the angle elements or “spectacles”, the floating support of the suction nozzles is no longer operative, as a result of which problems can occur as a result of positioning errors or manufacturing tolerances, especially when the printing plates are set down and threaded onto a plate cylinder.

### SUMMARY OF THE INVENTION

The invention aims to modify the handling device described in the journal cited above so that objects to be handled, such as printing plates, can be held down on the handling device at the same height, at least on a section-by-section basis, where in particular it is nevertheless guaranteed that positioning errors or manufacturing tolerances can be compensated when the objects being handled are set down.

According to the invention, a handling device for a printing press, especially for the handling of printing plates during an automated change of plates on a printing unit of a printing press, includes a manipulator arm, where a manipulator head having a handling element in the form of a suction device is assigned to one end of the manipulator arm. The suction device includes several sections along its length, each section having at least one suction nozzle, which is supported in floating fashion on a support element by connecting means, where a stop element is assigned to each suction nozzle to limit the movement of the object being handled toward the suction device as a result of the suction being exerted on it by the suction nozzle. The stop elements of the suction nozzles of each section, each section having at least one nozzle, are attached to the suction nozzle side of the suction device.

This guarantees that a handled object such as printing plate can be held at the same height on the manipulator head over the entire width of the printing plate, where the separate attachment of the stop elements on the suction nozzle side guarantees that a handled object, once picked up, is held with sufficient flexibility on the suction nozzle and the assigned stop element that the compensation of positioning errors and/or manufacturing tolerances is guaranteed.

According to an embodiment of the invention, the suction nozzles have an oval cross section.

With this design it is possible for the suction nozzle to extend over a greater length of each section, as a result of which, once the object to be handled has been picked up, it is even less likely that it will be at a slant.

According to an embodiment of the invention, each section has two suction nozzles supported on a common support element, where the stop elements of the two suction nozzles of each section are connected to each other.

According to an embodiment of the invention, the stop elements of the suction nozzles of each section are supported in floating fashion in common with their assigned suction nozzles.

In other words, according to one embodiment of the invention, a stop unit or spectacle, each formed by two stop elements, can be attached section by section to the suction nozzles, i.e., to the support side of the suction nozzles designed as suction cups, and thus float along with them, as a result of which, for example, when suction is being exerted on the printing plates, the stop unit of each section will move jointly with its associated suction nozzles.

This prevents frictional forces acting between the stop unit of the individual section and the handled object, such as a printing plate being held there by suction, from rendering the floating support of the suction nozzles inoperative when the handled object is being positioned so that it can be set down. Thus, in the presence of positioning errors or manufacturing tolerances, the suction nozzles of a section will be able to move jointly with their associated stop unit or spectacle, as a result of which positioning is facilitated, and damage to the handled object caused by the sliding of the handled object along the stop elements is avoided.

According to an embodiment of the invention, the stop element of each suction nozzle can be brought into a working position, in which it limits the movement of the object being suctioned by this particular suction nozzle toward the suction device, and into a nonworking position, in which it does not limit the suction-caused movement.

According to an embodiment of the invention, the stop elements can be brought into the working position and into the nonworking position on a section-by-section basis and also in groups of multiple sections.

Because of the possibility of bringing the stop elements into the working position or into the nonworking position on a section-by-section basis, that is, because of the possibility of moving the two stop elements of each section jointly and of moving the individual sections themselves separately or jointly, the user can adapt the inventive handling device to the number and to the width of the objects to be handled such as printing plates.

On a plate cylinder of a printing unit of a printing press, it is therefore possible to change only some of the printing plates arranged on the plate cylinder or to set down only some of the plates to be arranged on the cylinder, where printing plates which are not to be changed and/or adjacent sections are neither damaged nor negatively affected.

According to an embodiment of the invention, each of the stop elements has a contact surface, against which an object to be handled can be placed, where the contact surface has a macro-roughness to prevent the object on which suction is being exerted from slipping along the contact surface.

This is especially advantageous in cases where the objects are sticking with a certain force in the positions from which they are to be picked up. An example of this is, for example, when used printing plates are to be removed from a plate cylinder. Such used printing plates are usually covered with printing ink, as a result of which the printing plate can remain stuck to the plate cylinder even after the tension holding it there has been released. This can be especially critical after long pauses in production, during which the applied printing ink is able to dry out.

“Macro-roughness” according to the invention is to be understood as a roughness which guarantees that the static friction between the contact surface of the stop elements and the surface of the object to be handled resting on it is strong enough to guarantee a self-locking effect.

According to an embodiment of the invention, the macro-roughness is formed by a coating applied to the individual contact surfaces.

According to an embodiment of the invention, a vibration device is provided on the manipulator head to vibrate the suction nozzles of all the sections in common.

According to an alternative embodiment of the invention, a vibration device is provided on each section of the suction device so that the suction nozzles of the individual sections can be vibrated on a section-by-section basis.

The common or section-by-section vibration of the suction nozzles assists the loosening of objects such as used printing plates stuck fast by printing ink in the positions from which they are to be picked up.

According to an embodiment of the invention, in cases where a vibration device is provided on each section, the vibration devices can be turned on and off separately or jointly.

According to an embodiment of the invention, the handling element extends over the entire axial dimension of the plate cylinders of a printing unit of a printing press.

In this context it should be noted that, according to the invention, the axial dimension of these plate cylinders can correspond to a multi-page-wide printing press, especially a 4-page-wide, a 6-page-wide, an 8-page-wide, or a 10-page-wide printing press. That is, the axial length of the plate cylinders can be such that a plurality of vertical or horizontal print pages, especially four, six, eight, or ten vertical or horizontal pages, can be arranged along this dimension.

According to an embodiment of the invention, the length of each section corresponds to the area which a vertical or horizontal print page occupies in the axial direction of one of the associated plate cylinders.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows a schematic diagram of a printing unit of a web-fed printing press together with an inventive handling device;

FIG. 2 shows a perspective view of the basic structure of an inventive handling device, where the stop unit has been left out;

FIG. 3 shows a side view of the handling device of FIG. 2, where the stop unit has been left out;

FIG. 4 shows a front view of the handling device of FIG. 2, where the stop unit has been left out;

FIG. 5 shows a section of the handling device of FIG. 2, where the stop unit has been left out;

FIG. 6 shows a perspective view of a section of the inventive handling device of FIG. 2, where the stop unit with its stop elements is mounted on the suction device.

### DETAILED DESCRIPTION OF THE PRESENTLY PREFERRED EMBODIMENTS

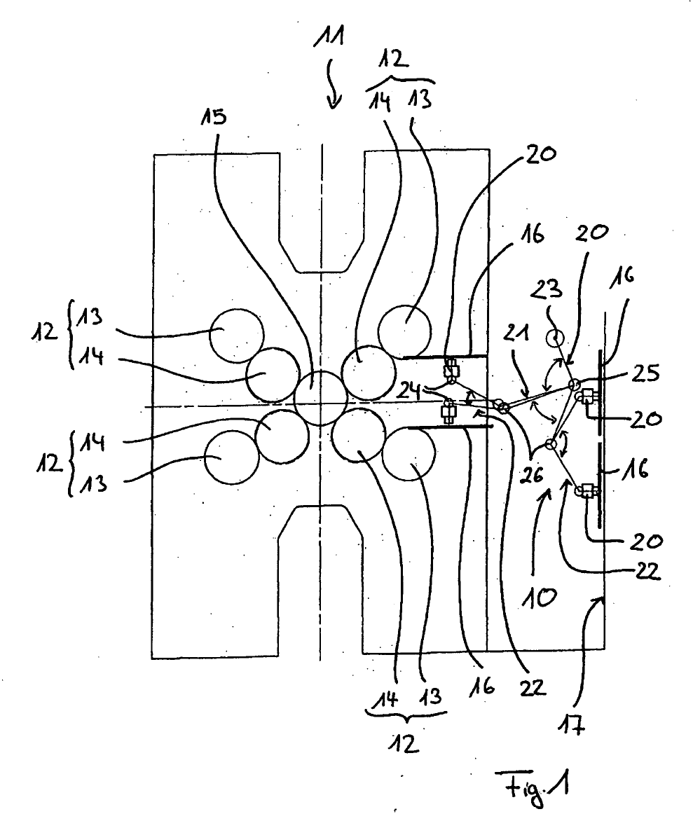

FIG. 1 shows a schematic diagram of an inventive embodiment of a handling device 10 for a printing press together with a printing unit 11, designed as a satellite printing unit, of a web-fed rotary printing press. The satellite printing unit 11 has four printing couples 12, where only the plate cylinders 13 and transfer cylinders 14 of each printing couple 12 are shown. All of the transfer cylinders 14 of the printing couples 12 roll on a satellite cylinder 15.

In the embodiment shown here, the inventive handling device 10 is used to handle printing plates 16 during an automatic or automated change of printing plates on the printing couples 12 of the printing unit 11. FIG. 1 shows the handling device 10 in a total of four different positions, to illustrate that the device can be shifted around flexibly in space. In two of the illustrated positions, the handling device 10 is picking up printing plates 16, which are being held ready on a web guide wall 17. In the two other positions shown, the handling device 10 is setting the printing plates 16 down on the plate cylinders 13 of the printing couples 12.

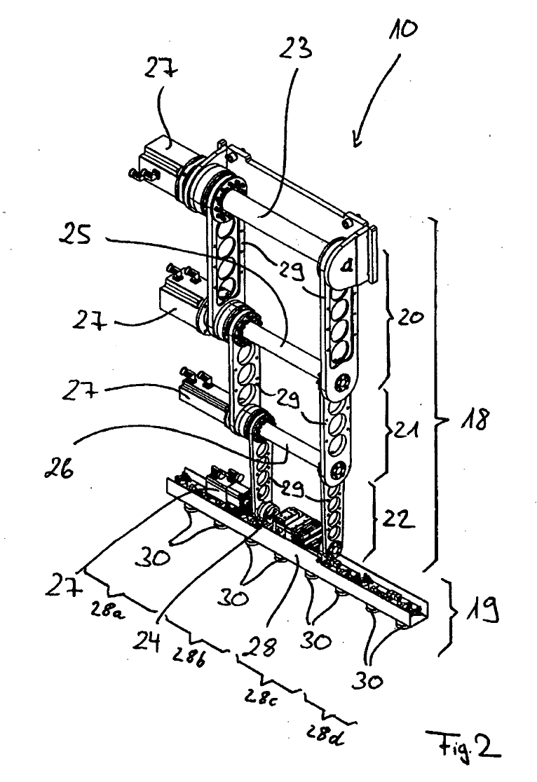

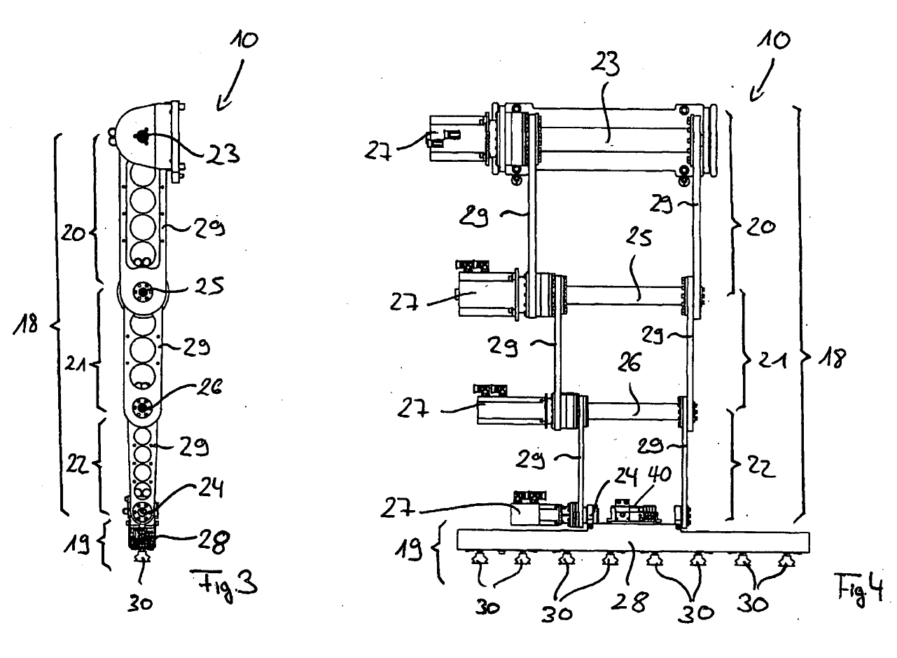

As shown in FIGS. 2-4, the handling device 10 includes a manipulator arm 18 and a manipulator head 19, where the manipulator head 19 includes a handling element.

The manipulator arm 18 is a multi-part arm consisting of several segments. In the embodiment shown here, the manipulator arm 18 includes three segments 20, 21, and 22. A first segment 20 is used to connect the manipulator arm 18 to a stand or to a wall of the printing press; a second segment 22 is used to connect the manipulator head 19 to the manipulator arm 18; and an intermediate segment 21 is used to connect the first segment 20 to the second segment 22. In contrast to the embodiment shown, it is also possible for several intermediate segments to be present between the first segment 20 and the second segment 22.

A pivot axis is formed on each end of the segments 20, 21, and 22. Thus, a first pivot axis 23, by which the manipulator arm 18 is connected to the stand or to the wall of the printing press, is formed on the end of the first segment 20. A second pivot axis 24 is formed on the end of the second segment 22, which serves to connect the manipulator head 19 to the manipulator arm 18. Additional pivot axes 25 and 26 are formed on the ends of the segments 20, 21, and 22, by which the first segment 20 and the second segment 22 are connected to the intermediate segment 21. The pivot axis 23, which serves to connect the manipulator arm 18 to the stand or to the wall of the printing press, is preferably stationary.

Each pivot axis 23, 24, 25, and 26 has its own separate drive 27 so that the segments 20, 21, and 22 can pivot relative to each other, so that the manipulator head 19 can pivot relative to the second segment 22 of the manipulator arm 18, and so that the first segment 20 of the manipulator arm 18 can pivot relative to the stand or to the wall of the printing press. The drives 27 are in the form of electric motors. The drives 27 make it possible to pivot individually each segment 20, 21, and 22 of the manipulator arm 18 and the manipulator head 19.

In the embodiment shown here, each segment 20, 21, 22 of the manipulator arm 18 is formed by two struts 29, extending parallel to each other. A pivot axis is assigned to each end of a strut 19 and thus to each end of a segment 20, 21, and 22.

In the embodiment shown here, the handling element is designed as a suction device 28 having multiple suction nozzles 30. The handling element can be replaceable, so that, for example, a suction device 28 for handling printing plates 16 can be replaced by a blanket wash-up unit or some other type of handling element. The handling element extends over the entire axial dimension of the plate cylinders 13 of the printing couples 12 of the printing unit 11.

The suction device 28 includes several sections 28a, 28b, 28c, 28d (see FIG. 2) extending along its length, each with two suction nozzles 30. According to this embodiment, each pair of suction nozzles 30 serves to handle one printing plate 16, so that, with the suction device 28 shown in FIGS. 2-4, a total of four printing plates 16 can be handled. It should be pointed out that the number of suction nozzles 30 present here is purely and depends on the number of printing plates 16 to be handled per plate cylinder 13 and/or on the axial length of the cylinder, which, according to embodiments of the invention not shown here, can also correspond to a 6-page-wide, to an 8-page-wide, or to a 10-page-wide printing press.

FIG. 5 shows a section 28a, 28b, 28c, or 28d of the suction device 28 of the manipulator head 19 with the two suction nozzles 30 belonging to it. The two suction nozzles 30 are attached to a floating support element 31 designed as a plate, where the floating support element 31 and thus the two suction nozzles 30 are supported in floating fashion in the suction device 28 by four ball rollers 32, where two ball rollers 32 cooperate with the top side of the support element 31 and two ball rollers 32 cooperate with the bottom side of the support element 31.

The ball rollers 32 cooperating with the bottom side of the floating support element 31 are attached to a crossbeam 33 of the suction device 28, whereas the ball rollers 32 cooperating with the top side of the support element 31 are attached to a fixed support plate 34. The support plate 34 is fixed to the cross beam 33 by spacers 39.

Locking bolts 35 of a locking device cooperate with the ball rollers 32. The bolts are able to slide axially in the direction of the arrows 36. The locking bolts 35 pass through the floating support element 31 and the crossbeam 33 and are guided in guide elements 37 assigned to the crossbeam 33. The locking bolts 35 enable the floating support of the two suction nozzles 30, so that the floating support element 31 can be tipped to a certain extent together with the suction nozzles 30. To fix the support element 31 in position and thus to block the floating support of the suction nozzles 30, the locking bolts 35 are moved downward from the position shown in FIG. 5, so that the bevels 38 assigned to the locking bolts 35 engage with corresponding bevels on the support element 31. Then, when printing plates 16 are to be picked up and transported, the locking bolts 35 block the floating support of the support element 31 and thus of the suction nozzles 30. If, however, the printing plates 16 are to be transferred to a plate cylinder 13 and threaded into a clamping channel of the plate cylinder 13, the locking bolts 35 enable the floating support of the support element 31 and thus of the suction nozzles 30.

Negative pressure in the area of the suction nozzles 30 is provided by compressed air elements 39.

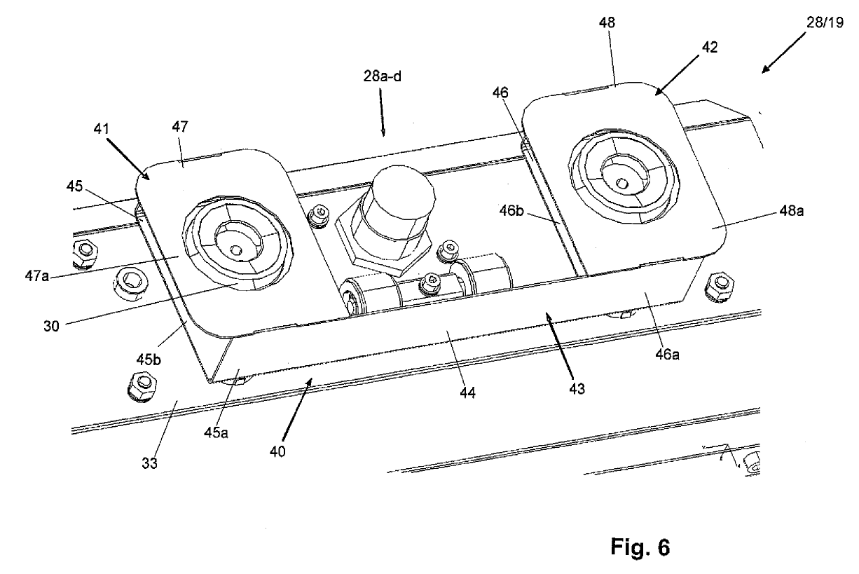

FIG. 6 shows one of the sections 28a-28d of the suction device 28 with an inventive stop unit 40 mounted thereon. The stop unit 40, which resembles the shape of a spectacle, includes two stop elements 41 and 42 connected to each other by a web 44 of a base element 43 of the stop unit 40. The base element 43 also includes two U-profile-shaped sections 45 and 46 having web sections 45b, 46b, in each of which a circular opening (not shown) is formed. The diameter of each opening is sufficiently large that, as shown in FIG. 6, an individually assigned suction nozzle 30 (here a rubber suction cup) can pass freely through. The web sections 45b, 46b are attached to the crossbeam 33 of the suction device 28 by fastening means (such as screws).

Each of the U-profile-shaped sections 45, 46 is also formed with two side-piece sections 45a, 46a, which extend at a right angle from the associated web sections 45b, 46b at opposite ends of base element 43. An elongated projection 45c, 46c is formed on the free end of each of the side-piece sections 45a and 46a.

Each stop element 41, 42, further includes a stop plate 47, 48, the size of which corresponds essentially to that of the corresponding web section 45b, 46b and includes a circular opening, the diameter of which is the same as that of the opening in the associated web section 45b, 46b and is aligned with it.

The individual stop plates 47, 48 lie on the free ends of the associated side-piece sections 45a, 46a, where the projections 45c, 46c provided on the side-piece sections 45a, 46a engage in corresponding recesses in the stop plates 47, 48. The stop plates 47, 48 are attached to the associated side-piece sections 45a, 46a by means of a suitable fastening method such as adhesive bonding, brazing, or welding. The side-piece sections 45a, 46a on one side of the U-profile-shaped sections 45, 46 are connected integrally to each other by the web 44.

According to the invention, the side-piece sections 45a, 46a extend from their associated web sections 45b, 46b by such an amount that the two stop plates 47, 48 lie on a common plane. According to this embodiment, the two stop plates 47, 48 are arranged at distance from the crossbeam 33 such that the suction nozzles 30 in question project through the openings and above the stop plates 47, 48 by a predetermined minimum amount for suctioning.

When suction is now to be exerted on an object to be handled such as a printing plate 16 by means of the two suction nozzles 30, designed as rubber suction cups, of one section 28a-28d, the suction nozzles 30 are compressed until the printing plate 16 comes to rest against the associated contact surfaces 47a, 48a of the stop plates 47, 48.

Thus the printing plate 16 is aligned parallel to the crossbeam 33, where, because of the floating support of the suction nozzles 30, they are also supported in floating fashion.

According to an embodiment of the invention, the stop unit 40 of each section 28a-28d can be brought into a working position, in which it limits the movement of the object to be handled toward the crossbeam 33 as a result of the suction being exerted on it by the suction nozzles 30 of the associated section 28a-28d, and into a nonworking position, in which it does not limit this suction-caused movement.

For this purpose, according to an embodiment of the invention, adjusting elements in the form of, for example, pneumatic cylinders (not shown) are installed between the crossbeam 33 and the web sections 45b, 46b of the two U-profile-shaped sections 45, 46 of the base element 43. Because the jointly actuated pneumatic cylinders of an individual section 28a-28d connect the web sections 45b, 46b to the crossbeam 33, they can be used to adjust the distance between the stop plates 47, 48 and the crossbeam 33 by such an amount that these plates and/or the entire stop unit 40, as needed, can be moved into the working or nonworking position.

In this embodiment, the side-piece sections 45a, 46a have a length from their associated web sections 45b, 46b such that the two stop plates 47, 48, when in the nonworking position, are so close to the crossbeam 33 that the associated suction nozzles 30 project completely freely out of the associated openings in the stop plates 47, 48, so that, when suction is being exerted on a printing plate 16, for example, this plate cannot come to rest against the stop plates 47, 48. In the working position, however, the stop plates 47, 48 are at such a distance from the crossbeam 33 that the suction nozzles 30 again project freely out of the opening in the associated stop plates 47, 48 by the minimum amount necessary for suction.

To prevent vibration of the pneumatic cylinders when in the working position, these cylinders can also have a selectively actuatable locking system.

According to an embodiment of the invention, the stop elements 41, 42 and/or the stop units 40 of all sections 28a-28d can be moved by the associated adjusting elements either section-by-section or jointly in groups of several units into the working position and into the nonworking position. For this purpose, all of the adjusting elements are connected to a control unit (not shown), which can drive the adjusting elements as needed.

According to an embodiment of the invention, the contact surfaces 47a, 48a of the stop plates 47, 48 have a macro-roughness to prevent the object being handled, such as, for example, a printing plate 16, from slipping on the contact surfaces 47a, 48a as suction is being exerted on it. “Macro-roughness” is to be understood in accordance with the invention as a roughness which ensures enough static friction between the contact surfaces 47a, 48a and, for example, the surface of a printing plate 16 located on these contact surfaces, that a self-locking effect is guaranteed.

The macro-roughness may be formed by a coating applied to the contact surfaces 47a, 48a.

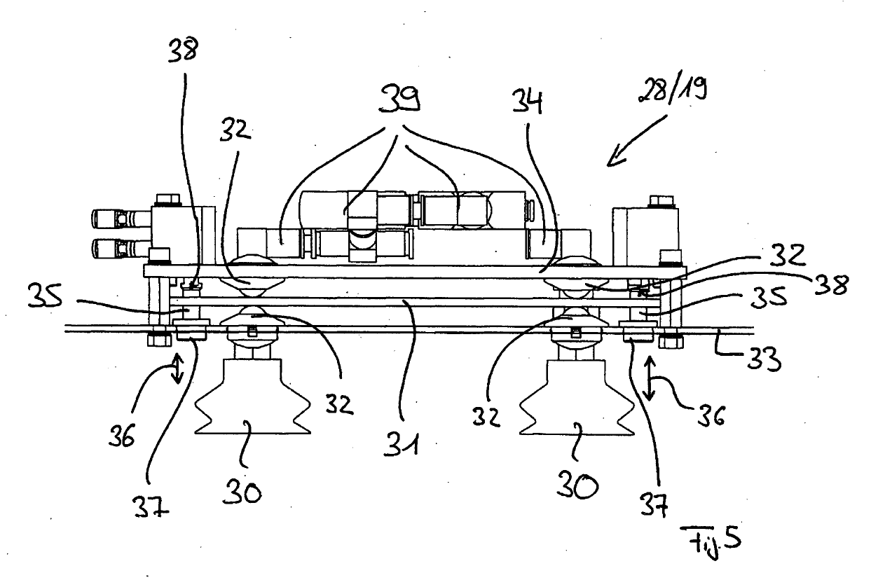

According to an embodiment of the invention, a vibration device 40 (FIGS. 2 and 4) is provided on the manipulator head 19 to vibrate the suction nozzles 30 of all the sections 28a-28d jointly. The vibration device is also connected to the control unit, so that it can be turned on and off.

According to an alternative embodiment of the invention, a vibration device (not shown) is provided on each section 28a-28d of the suction device 28 to vibrate the suction nozzles 30 of the individual sections 28a-28d. The vibration devices are also connected to the control unit, so that they can be turned on and off either separately or together.

The vibration device or vibration devices can be used, for example, to assist the process of threading the printing plates 16 into the clamping channel of a plate cylinder 13 and the process of loosening printing plates 16 which have become firmly stuck to the plate cylinder 13.

The invention is not limited by the embodiments described above which are presented as examples only but can be modified in various ways within the scope of protection defined by the appended patent claims.

We claim:

1. A handling device for handling printing plates during an automated change of printing plates on a printing unit of a printing press, the apparatus comprising:
a manipulator arm having a free end; and
a manipulator head mounted on the free end, the manipulator head comprising a crossbeam having a length and a plurality of suction sections along said length, each said suction section comprising:
at least one suction nozzle supported in floating fashion with respect to the crossbeam and designed to hold a printing plate by suction; and
a stop element assigned to each said suction nozzle, each said stop element being mounted on the crossbeam and arranged to limit the movement of a printing plate held by a respective said suction nozzle with respect to the crossbeam.

2. The handling device of claim 1 wherein each said suction section comprises a support element that is fixed with respect to the crossbeam, a pair of said suction nozzles supported in floating fashion with respect to the support element, and a pair of said stop elements assigned to respective said suction nozzles.

3. The handling device of claim 1 wherein the stop elements are fixed with respect to the crossbeam.

4. The handling device of claim 1 wherein the stop elements are adjustably mounted on the crossbeam, and are movable between a working position, wherein movement of the printing plate with respect to the crossbeam is limited by the stop elements, and a non-working position, wherein movement of the printing plate with respect to the crossbeam is not limited by the stop elements.

5. The handling device of claim 4 wherein the stops elements of each section can be moved into the working position and the non-working position independently of the stop elements of other said sections.

6. The handling device of claim 1 wherein each said stop element has a contact surface which comes into contact with the printing plate, the contact surface having a macro-roughness to prevent a printing plate being held by suction from sliding relative to the contact surface.

7. The handling device of claim 1 wherein the macro-roughness is formed by a coating on the stop element.

8. The handling device of claim 1 further comprising at least one vibration device mounted on the manipulator head for vibrating at least one of said suction sections.

9. The handling device of claim 8 wherein one said vibration device on the manipulator head vibrates all of the suction sections jointly.

10. The handling device of claim 8 wherein each said vibration device can be turned on and off separately.

11. The handling device of claim 1 wherein each said suction section comprises at least one U-profile-shaped section having a web section fixed to the crossbeam and a pair of side pieces upstanding from the web section, each said side piece having a free end, each said stop element being fixed to the free ends of one of said U-profile-shaped sections, each said web section and each said stop element having an opening through which a respective said suction nozzle projects.

12. The handling device of claim 11 wherein each said suction section comprises a pair of said U-profile-shaped sections connected by web to form a single piece.
